(19) United States
(12) Patent Application Publication
(10) Pub. No.: US 2002/0021698 A1
(43) Pub. Date: Feb. 21, 2002

(54) Data transmission method for hybrid ARQ type II/III uplink for a wide-band radio communication system

(76) Inventors: Yu-Ro Lee, Seoul (KR); Jae-Hong Park, Seoul (KR); Chong-Won Lee, Seoul (KR); Jeong Hwa Ye, Seoul (KR)

Correspondence Address: BAKER & BOTTS, 30 ROCKEFELLER PLAZA, NEW YORK, NY, 10112

(21) Appl. No.: 09/832,251

(22) Filed: Apr. 10, 2001

(30) Foreign Application Priority Data
Apr. 10, 2000 (KR) 2000-18646
May 16, 2000 (KR) 2000-25966
Jun. 26, 2000 (KR) 2000-35455
Jun. 26, 2000 (KR) 2000-35456
Aug. 4, 2000 (KR) 2000-45160
Aug. 21, 2000 (KR) 2000-48435
Oct. 27, 2000 (KR) 2000-63615

(51) Int. Cl. H04L 12/28

(52) U.S. Cl. 370/394; 370/469

(57) ABSTRACT

A data processing method for the hybrid ARQ type II/III on a uplink of a wide-band radio communication system includes the steps of: a) generating a radio link control protocol data unit (hereinafter, referred to as a RCL-PDU) used for combining pre-transmitted data and re-transmitted data with a changeable coding rate in a radio link control (hereinafter, referred to as a RLC) layer and, and protocol data unit which includes information of the RLC-PDU (hereinafter, referred to as a HARQ-RLC-Control-PDU); b) transmitting the RLC-PDU and the HARQ-RLC-Control-PDU to a medium access control dedicated (hereinafter, referred to as a MAC-D) treating a general user part in a medium access control (hereinafter, referred to as a MAC) layer through a logical channel; c) transforming the RLC-PDU and the HARQ-RLCControl-PDU received from the receiver RLC layer to MAC-PDU and HARQ-MAC-ControlPDU and transmitting the transformed MAC-PDU and the HARQ-MAC-Control-PDU to the physical layer through a transport channel; and d) transforming the MAC-PDU and the HARQMAC-Control-PDU received from the MAC-D to a radio transmission form and then transmitting them to a receiver through the physical layer.

### FIELD OF THE INVENTION

The present invention relates to a data processing method for hybrid automatic repeat for request (hereinafter, referred to as an ARQ) type II/III on an uplink of a wide-band radio communication system; and, more particularly, to a method for processing a radio link control-protocol data unit (RLC-PDU) and a HARQ-RLC-Control-PDU, which is extracted from the RLC-PDU, by using a transport channel such as an uplink shared channel (DSCH), wherein the RLC-PDU is used in W-CDMA based on a next generation mobile communication network, such as an international mobile telecommunication (IMT)-2000 and a universal mobile telecommunications system (UMTS), and to a recording media having a computer readable program for carrying out the method.

### DESCRIPTION OF THE PRIOR ART

Terms used in this specification will be described.

“A radio network controller-radio link control (RNC-RLC)” is a radio link control protocol level entity of a radio network controller (RNC).

“A radio network controller-medium access control dedicated entity (RNC-MAC-D)” is a medium access control protocol level dedicated entity of a radio network controller (RNC).

“A radio network controller-medium access control common/shared entity (RNC-MAC-C/SH)” is a medium access control protocol level terminal common/shared entity of a radio network controller (RNC).

“Node B-LI” is a physical channel layer entity of a node B. The node B represents a base transceiver station (BTS) in an asynchronous IMT-2000 system. In this specification, the node B is used as the same meaning as the base transceiver station (BTS).

“User equipment-L1 (UE-L1)” is a physical channel level entity of a user equipment (UE) (or a mobile station).

“User equipment-medium access control common/shared entity (UE-MAC-C/SH)” is a medium access control protocol level terminal common/shared entity of a user equipment (UE) (or a mobile station).

“User equipment-medium access control dedicated entity (UE-MAC-D)” is a medium access control protocol level terminal dedicated entity of a user equipment (UE) (or a mobile station).

“User equipment-radio link control (UE-RLC)” is a radio link control protocol level entity of a user equipment (UE) (or a mobile station).

“User equipment-radio resource control (UE-RRC)” is a radio resource control protocol level entity of a user equipment (UE) (or a mobile station). “Iub” denotes an interface between the RNC and the Node B (BTS).

“lur” denotes an interface between the RNC and another RNC.

“Uu” denotes an interface between the Node B and the UE.

“Logical channel” is a logical channel used for transmitting and receiving data between the RLC protocol entity and MAC protocol entity.

“Transport channel” is a logical channel used for transmitting and receiving data between the MAC protocol entity and a physical layer.

“Physical channel” is a practical channel used for transmitting and receiving data between a mobile station and a BTS.

When transporting the data from a radio network of a UMTS terrestrial radio access network (UTRAN) to the mobile station (MS), a Hybrid ARQ type II/III which has superior throughput than a Hybrid ARQ type I may be used.

FIG. 1 is a diagram showing a general wide-band radio communication network (W-CDMA). A UTRAN environment is used as an example in this drawing.

As described in FIG. 1, the UTRAN includes a user equipment (UE) 100, an asynchronous radio network 200 and a radio communication core network 300, such as a GSM-MAP core network.

A Hybrid ARQ type II/III is adapted between the UE and the asynchronous radio network 200. When a received data has an error, a receiver requests a transmission part to re-transmit the received data.

A protocol stack structure in the above-referenced interlocking structure is illustrated in FIG. 3.

FIG. 2 is a diagram showing a general UTRAN. In FIG. 2, the Iu is an interface between the radio communication core network 300 and the asynchronous radio network 200, and, the lur means a logical interface between radio network controllers (RNC) of the asynchronous radio networks 200 and the lub shows an interface between the RNC and the Node B. Meanwhile, the Uu shows a radio interface between the UTRAN and the UE.

In here, the Node B is a logical node, which is responsible for a radio transmission/receiving from one or more cell to the UE.

Generally in the UTRAN, if a received data has an error, the receiver requests re-transmission of the data to the transmission part by using an automatic repeat request (ARQ) method. The ARQ method is divided to ARQ type I, II and III, and technical characteristics of each type are described below.

The ARQ is an error control protocol, which automatically senses an error during transmission and then requests re-transmission of the error-containing block. That is, the ARQ is one of data transmission error control methods, and when an error is detected, automatically generates a re-transmission request signal to cause re-transmission of the data.

The ARQ method is used in the UTRAN for a transmission packet data. The receiver requests the transmission part to re-transmit an error-containing packet. However, when using the ARQ method, if the number of re-transmission requests are increased, then the throughput, which is amount of data to be transmitted in a predetermined period, may be decreased. To solve the problem, the ARQ can be used along with a forward error correction coding (FEC) method, which is called a hybrid ARQ.

The hybrid ARQ has three types I, II and III.

In case of type I, one coding rate is selected, for example, one coding rate selected from no coding, rate 1/2 and rate 1/3 of convolutional codings, according to channel environment or required quality of service (QoS) and the selected coding rate is continuously used. If there is a re-transmit request, the receiver removes pre-received data and the transmission part re-transmits the data with the pre-transmitted coding rate. In this case, the coding rate is not changed according to changeable channel environment, so, when compared with the type II and III the throughput may be decreased.

In case of type II ARQ, if the receiver requests data re-transmission, then the data is stored onto a buffer at the receiver and the stored data is combined with the re-transmitted data. That is, at first, the data is transmitted with a high coding rate and in case of re-transmitting, the data is transmitted with a low coding rate and it is combined with the pre-received stored data to increase efficiency compared to the type I. For example, a convolutional coding rate 1/4, which is a mother code, may generates coding rates 8/9, 2/3 or 1/4 by puncturing and it is called a rate compatible punctured convolutional (RCPC) code.

Meanwhile, a rate compatible punctured turbo (RCPT) code is obtained by puncturing a turbo code. At first, a data is transmitted with a coding rate of 8/9, and this version of the data is called ver (0), an error is detected in the data by checking a cyclic redundancy check (CRC) and the data is stored to a buffer and re-transmission is requested. At this time, the re-transmission is performed with a coding rate 2/3 and the re-transmission version is designated ver (1).

The receiver combines the ver (0) data stored in the buffer and the ver(1) data, then the combined data is decoded and checked by the CRC. The above-referenced process is repeated until no error is detected, then, the last transmitted ver(n) is combined with a pre-transmitted ver(n-a)(0<a<n).

The type III ARQ is similar to the type II ARQ. It is different in that the re-transmitted ver(n) data is decoded before combined with the ver(n-a) data, and checked by the CRC then, if there is no error, the ver(n) data is transmitted to an upper layer. If an error is detected, the re-transmitted ver(n) data is combined ver(n-a), checked by the CRC to determine if further data re-transmission is necessary.

Accordingly, the hybrid ARQ type II/III is used for efficient data transmission in the UTRAN.

The hybrid ARQ type II/III combines a first data which is encoded with a high coding rate and a re-transmit data which is encoded with a low coding rate in the receiver to increase the throughput. Therefore, relational information between a sequence number and a re-transmitted version of a protocol data unit (PDU) is needed to be known in advance. The relation information should be transmitted with a low coding rate, regardless of the re-transmission coding rate, thereby ensuring its quality of communication.

However, for the hybrid ARQ type II/III in the UTRAN, the data is transmitted with the high coding rate, thereby increasing the possibility of an error of a header of a RLC-PDU. Therefore, a method of stably transmitting the RLC-PDU header is required.

### SUMMARY OF THE INVENTION

It is, therefore, an object of the present invention to provide a data delivery method for hybrid ARQ type II/Ill on the uplink of wide-band radio communication system and a computer readable recording media having program instructionS for performing the method.

In accordance with an aspect of the present invention, there is provided a data processing method for the hybrid ARQ type II/III on a uplink of a wide-band radio communication system, comprising the steps of: a) generating a radio link control protocol data unit (hereinafter, referred to as a RCL-PDU) used for combining pre-transmitted data and re-transmitted data with changeable coding rate in a radio link control (hereinafter, referred to as a RLC) layer, and a protocol data unit which includes information from the RLC-PDU (hereinafter, referred to as a HARQ-RLC-Control-PDU); b) transmitting the RLC-PDU and the HARQ-RLC-Control-PDU to a medium access control dedicated (hereinafter, referred to as a MAC-D) treating a general user part in a receiver medium access control (hereinafter, referred to as a MAC) layer through a logical channel; c) transforming the RLC-PDU and the HARQ-RLC-Control-PDU received from the receiver RLC layer to MAC-PDU and HARQ-MAC-Control-PDU and transmitting the transformed MAC-PDU and the HARQ-MAC-Control-PDU to a physical layer through a transport channel; and d) transforming the MAC-PDU and the HARQ-MAC-Control-PDU received from the MAC-D to a radio transmission form and then transmitting them to a receiver through the physical layer.

The present invention further includes the steps of: e) storing a received RLC-PDU to a buffer and generating a data identifier to identify the RLC-PDU, then transmitting the RLC-PDU and the HARQ-RLC-Control-PDU to the MAC-D of the receiving MAC layer, through a transport channel; f) transmitting the HARQ-RLC-Control-PDU and the data identifier to the receiving RLC layer through a logical channel; g) transmitting a sequence number and a version number acquired by analyzing the HARQ-RLC-Control-PDU to a radio resource control (hereinafter, referred to as a RRC) layer with the data identifier; h) transmitting the sequence number, the version number and the data identifier to the physical layer; i) determining whether to decode the RLC-PDU stored in the buffer directly by using the sequence number, the version number and the data identifier or to decode after combining with the RLC-PDU of a previous version, then transmitting the RLC-PDU to a receiver physical layer; j) transmitting the decoded RLC-PDU to the MAC-D through the transport channel; k) transmitting the RLC-PDU received from the receiving physical layer to the receiving RLC layer through the logical channel; and l) transmitting the RLC-PDU after analyzing it in the RLC layer to an upper layer and transmitting a response to the receiver RLC layer.

In accordance with another aspect of the present invention, there is provided a data processing method for the hybrid ARQ type II/III on an uplink of a wide-band radio communication system, comprising the steps of: a) storing a radio link control protocol data unit (hereinafter, referred to as a RLC-PDU) to a buffer and generating a data identifier to identify the RLC-PDU, then, transmitting the RLC-PDU with a protocol data unit which includes information from the RLC-PDU (hereinafter, referred to as a HARQ-RLC-Control-PDU) to a medium access control dedicated (hereinafter, referred to as a MAC-D), which treats a general user equipment of a MAC layer, through a transport channel; b) transmitting the HARQ-RLC-Control-PDU and the data identifier to the RLC layer through a logical channel; c) transmitting a sequence number and a version number acquired by analyzing the HARQ-RLC-Control-PDU to a radio resource control (hereinafter, referred to as a RRC) with the data identifier; d) transmitting the sequence number, the version number and the data identifier to the physical layer; e) determining whether to decode the RLC-PDU stored in the buffer directly by using the sequence number, the version number and the data identifier or to decode the RLC-PDU after combining it with an RLC-PDU of a previous version, then, transmitting the decoded RLC-PDU to a physical layer; f) transmitting the decoded RLC-PDU to the MAC-D through the transport channel; g) transmitting the RLC-PDU received from the physical layer to the RLC layer through the logical channel; and h) transmitting the RLC-PDU after analyzing it in the RLC layer to an upper layer and transmitting a response to the RLC layer of the user equipment.

In accordance with further another aspect of the present invention, there is provided a computer readable data recording media having instructions for implementing a data processing method for a hybrid ARQ type II/III on a uplink of a wide-band radio communication system having a processor, comprising the functions of: a) generating a radio link control-protocol data unit (hereinafter, referred to as a RCL-PDU) used for combining pre-transmitted data and re-transmitted data with a changeable coding rate in a radio link control (hereinafter, referred to as a RLC) layer and a protocol data unit which includes information of the RLC-PDU (hereinafter, referred to as a HARQ-RLC-Control-PDU); b) transmitting the RLC-PDU and the HARQ-RLC-Control-PDU to a medium access control dedicated (hereinafter, referred to as a MAC-D) treating a general user part in a medium access control (hereinafter, referred to as a MAC) layer through a logical channel; c) transforming the RLC-PDU and the HARQ-RLC-Control-PDU received from the layer to MAC-PDU and HARQ-MAC-Control-PDU and transmitting the transformed MAC-PDU and the HARQ-MAC-Control-PDU to a physical layer through a transport channel; and d) transforming the MAC-PDU and the HARQ-MAC-Control-PDU received from the MAC-D to a radio transmission form and then transmitting them to a receiver through the physical layer.

The present invention further includes the functions of: e) storing a received RLC-PDU to a buffer and generating a data identifier to identify the RLC-PDU, then transmitting the RLC-PDU and the HARQ-RLC-Control-PDU to the MAC-D of the receiving MAC layer through the transport channel; f) transmitting the HARQ-RLC-Control-PDU and the data identifier to the receiving RLC layer through a logical channel; g) transmitting a sequence number and a version number acquired by analyzing the HARQ-RLC-Control-PDU to a radio resource control (hereinafter, referred to as a RRC) layer with the data identifier; h) transmitting the sequence number, the version number and the data identifier to the physical layer; i) determining whether to decode the RLC-PDU stored in the buffer directly by using the sequence number, the version number and the data identifier or to decode the RLC-PDU after combining it with the RLC-PDU of a previous version, then, transmitting the decoded RLC-PDU to a receiver physical layer; j) transmitting the decoded RLC-PDU to the MAC-D through the transport channel; k) transmitting the RLC-PDU received from the receiving physical layer to the receiving RLC layer through the logical channel; and l) transmitting the RLC-PDU after analyzing it in the RLC layer to an upper layer and transmitting a response to the receiver RLC layer.

In accordance with still further another aspect of the present invention, there is provided a computer readable data recording media having instructions for implementing a data processing method for a hybrid ARQ type II/III on a uplink of a wide-band radio communication system having a processor, comprising the functions of: a) storing a radio link control-protocol data unit (hereinafter, referred to as a RLC-PDU) to a buffer and generating a data identifier to identify the RLC-PDU then, transmitting the RLC-PDU with a protocol data unit which includes information from the RLC-PDU (hereinafter, referred to as a HARQ-RLC-Control-PDU) to a medium access control dedicated (hereinafter, referred to as a MAC-D), which treats a general user equipment of a MAC layer, through a transport channel; b) transmitting the HARQ-RLC-Control-PDU and the data identifier to the RLC layer through a logical channel; c) transmitting a sequence number and a version number acquired by analyzing the HARQ-RLC-Control-PDU to a radio resource control (hereinafter, referred to as a RRC) with the data identifier; d) transmitting the sequence number, the version number and the data identifier to the physical layer; e) determining whether to decode the RLC-PDU stored in the buffer directly by using the sequence number, the version number and the data identifier or to decode the RLC-PDU after combining it with an RLC-PDU of a previous version, then transmitting the decoded RLC-PDU to the physical layer; f) transmitting the decoded RLC-PDU to the MAC-D through the transport channel; g) transmitting the RLC-PDU received from the physical layer to the RLC layer through the logical channel; and h) transmitting the RLC-PDU after analyzing it in the RLC layer to an upper layer and transmitting a response to the RLC layer of the user equipment.

The present invention is a method for realizing the hybrid ARQ type II/III on the uplink of an asynchronous mobile communication system and may be adapted in a technical field where packet data service is used.

In an asynchronous communication system, the present invention of using the hybrid ARQ type II/III may increase system efficiency by combining pre-transmitted data and re-transmitted data with a changeable coding rate.

To perform the combining on the hybrid ARQ type II/III, the receiver may have information of the current receiving RLC-PDU, and the information composing part of the RLC-PDU should be transmitted more stably than a currently transmitted data.

For the above, the present invention generates the HARQ-RLC-Control-PDU referring to the RLC-PDU, wherein the HARQ-RLC-Control-PUD has information of the RLC-PDU which is used for supporting the hybrid ARQ type 11/111. At this time, the HARQ-RLC-Control-PDU includes sequence number and a version number of the RLC-PDU.

The RLC-PDU and the HARQ-RLC-Control-PUD are transmitted from a RLC protocol entity to a MAC-D protocol entity by using a different or same logical channel and transmitted from a MAC-C/SH protocol entity to a physical layer by using a dedicated channel (DCH) and transmitted to the receiver through a physical channel, such as a dedicated physical channel (DPCH).

### BRIEF DESCRIPTION OF THE DRAWINGS

Other objects and aspects of the invention will become apparent from the following description of the embodiments with reference to the accompanying drawings, in which:

FIG. 1 is a diagram showing a general W-CDMA network;

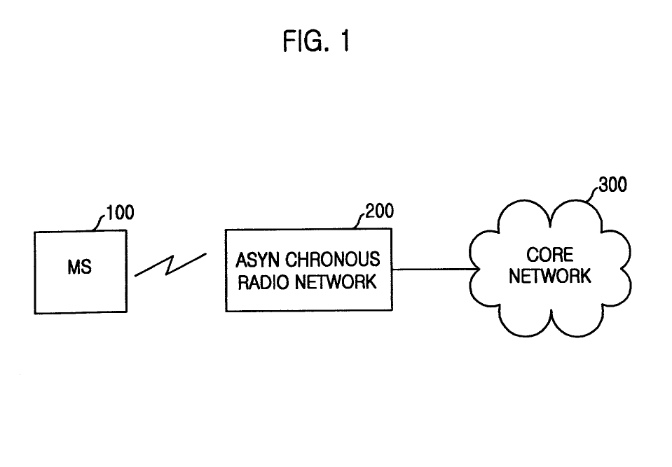

FIG. 2 is a diagram showing a general UTRAN;

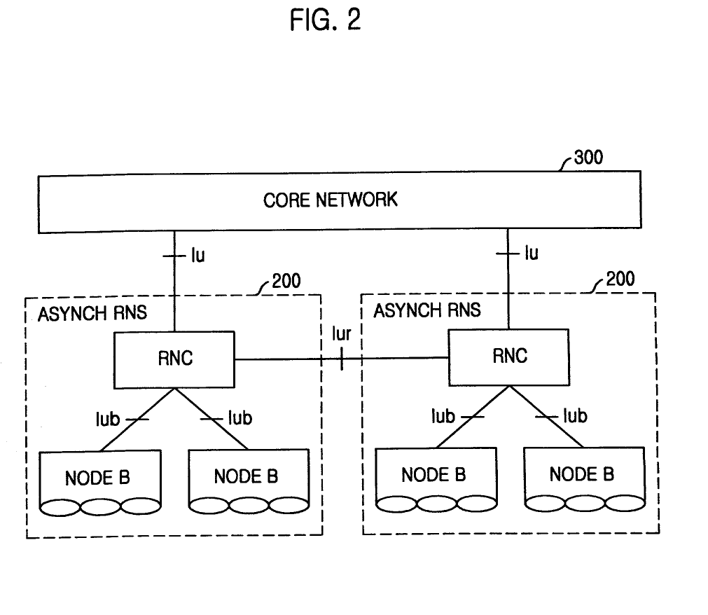

FIG. 3 is a diagram showing protocol stacks in UTRAN;

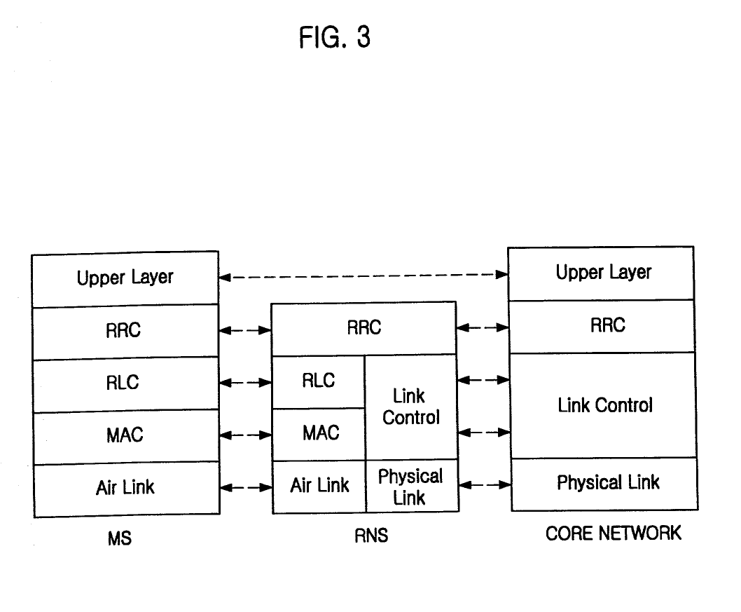

FIG. 4 is a diagram showing relations among conventional RLC-PU, RLCPDU, MAC-PDU and transport block;

FIG. 5 is a diagram showing a data processing method of a transmitting part in accordance with the present invention;

FIG. 6 is a diagram showing a data processing method of a receiver in accordance with the present invention; and

FIG. 7 is a flow chart showing a data processing method in accordance with the present invention.

### DETAILED DESCRIPTION OF THE PREFERRED EMBODIMENTS

Hereinafter, a data processing method for hybrid ARQ type II/III on a uplink of a wide-band radio communication system according to the present invention will be described in detail referring to the accompanying drawings.

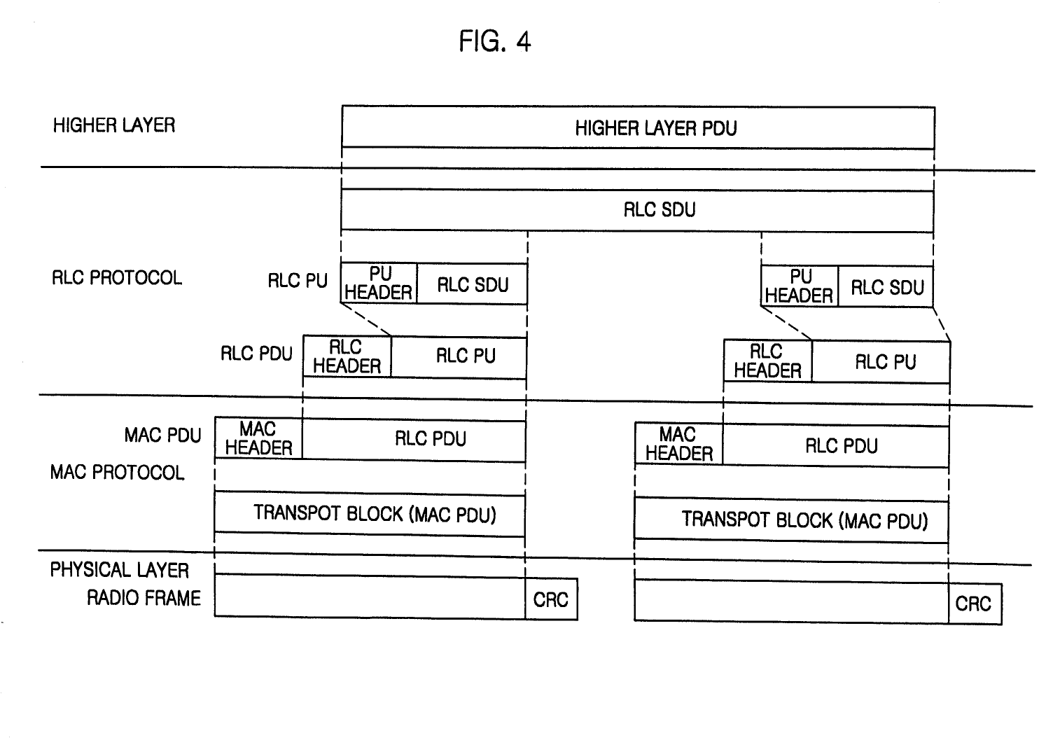

FIG. 4 is a diagram showing relations among conventional RLC-PU, RLC-PDU, MAC-PDU and transport block.

As described in FIG. 4, a RLC-PDU includes one or more RLC-PDU and the RLC-PDU is mapped to MAC-PDU. The MAC-PDU is mapped to a transmission block of a physical layer and then CRC is added thereto.

In the physical layer, the RLC-PDU is transmitted through an encoding unit, a rate matching unit, an interleaver and a modulating unit, and in a receiver, the RLC-PDU is passed a demodulating unit, a deinterleaver and a decoding unit and the CRC of the data is checked whether an error is exist or not in the transmitted data. If an error exists, the receiver requests a re-transmission of the data and the error-generating data is stored in the buffer. At this time, the re-transmitted RLC-PDU is combined with the RLCPDU stored in the buffer and performs the decoding process, then checks the CRC. In this case, the sequence number and the version number of the currently received RLC-PDU should be known. Also, in case of the hybrid ARQ type II/III, a beginning transmission is carried out with a high coding rate so, an error generating possibility of a header of the RLC-PDU is increased.

For the above, the present invention generates the HARQ-RLC-Control-PDU, which has information of the header of the RLC-PDU and transmits it with the RLC-PDU.

The RLC protocol entity generates the RLC-PDU and forms the HARQ-RLC-Control-PDU by referencing the information on the header of the RLC-PDU.

The RLC protocol entity transmits the RLC-PDU and the generated HARQ-RLC-Control-PDU to the MAC-D protocol entity. At this time, the RLC-PDU and the HARQ-RLC-Control-PDU can be transmitted through a different type or the same type of logical channel.

In case of using the different type of the logical channel, the RLC-PDU uses a logical channel, such as a dedicated traffic channel (DTCH) and the HARQ-RLC-Control-PDU uses a logical channel, such as DTTC and MAC-Data-REQ is used as a primitive.

In case of using the same type of the logical channel, the RLC-PDU and the HARQ-RLC-Control-PDU use a logical channel, such as DTCH and MAC-Data-REQ is used as a primitive.

The MAC-D protocol entity transforms the RLC-PDU and the HARQRLC-Control-PDU to MAC-PDU and HARQ-MAC-Control-PDU, respectively. Then, they are transmitted to the physical layer in a transport block form and PHY-Data-REQ is used as a primitive.

In the physical layer, CRC is added to a DCH transport block, and then the CRC is transmitted to the receiver through the physical channel, such as DPCH after the encoding unit, the rate matching unit, the interleaver and the modulating unit.

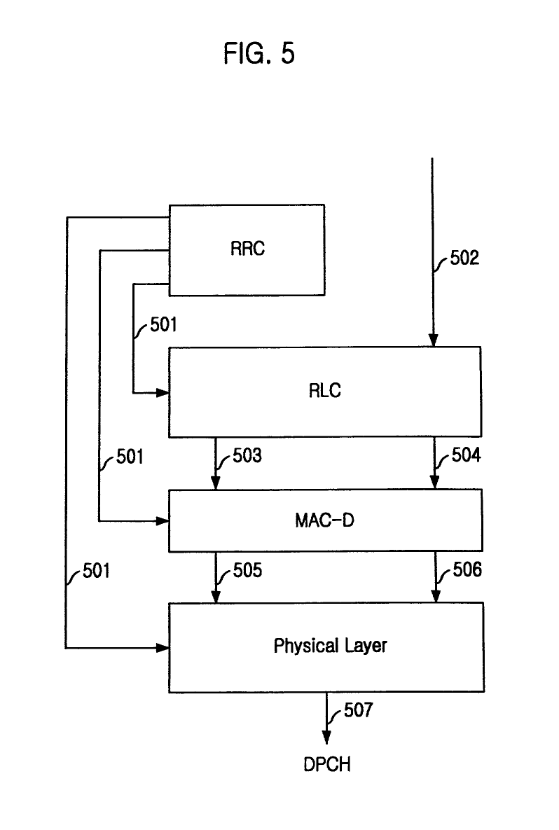

FIG. 5 is a diagram showing a data processing method of a transmitting part in accordance with the present invention.

As described in FIG. 5, the RLC protocol entity, the MAC-D protocol entity, the MAC-C/SH protocol entity and the physical layer are initialized by the RRC protocol entity to perform normal operation in each of the protocol entity at step 501.

After that, the RLC protocol entity receives a data, which should be transmitted to the receiver, from an upper layer at step 502. At this time, the RLC protocol entity converts the received data to the RLC-PDU and based on the RLC-PDU, the HARQ-RLC-Control-PDU is generated to use the hybrid ARQ type II/IIl. The generated RLC-PDU is transmitted to the MAC-D protocol entity through the logical channel, such as the DTCH at step 503, and the generated HARQ-RLC-Control-PDU is transmitted to the MAC-D protocol entity through the logical channel, such as the DTCH at step 504.

In case of using the same type of logical channel, the RLC protocol entity receives data, which is to be transmitted to the receiver, from the upper layer. Then the RLC protocol entity converts the received data to the RLC-PDU and the HARQ-RLC-Control-PDU is generated based on the header information of the RLC-PDU to use the hybrid ARQ type II/IIl. The generated RLC-PDU and the HARQ-RLC-Control-PDU are transmitted to the MAC-D protocol entity through the logical channel, such as the DTCH.

Next, the MAC-D protocol entity that receives the RLC-PDU from the RLC protocol entity transforms the received RLC-PDU to the MAC-PDU and transmits the MAC-PDU to the physical layer of the node B at step 505.

The MAC-D protocol entity, which receives the HARQ-RLC-Control-PDU from the RLC protocol entity, transforms the received HARQ-RLC-Control-PDU to the MAC-PDU (to differentiate the MAC-PDUs which are transformed from the RLC-PDU and the HARQ-RLC-Control-PDU, respectively, in this specification, the former is called to MAC-PDU and the latter to HARQ-MAC-Control-PDU), and transmits it to the physical layer of the node B through a transport channel, such as DCH at step 506.

After that, the physical layer of the node B, which receives the MAC-PDU and the HARQ-MAC-Control-PDU, carries out the encoding, the rate matching, the interleaving and the modulation to transform the MAC-PDU and the HARQ-MAC-Control-PDU to a radio frame, then transmits the radio frame to the receiver through a physical channel, such as DPCH at step 507.

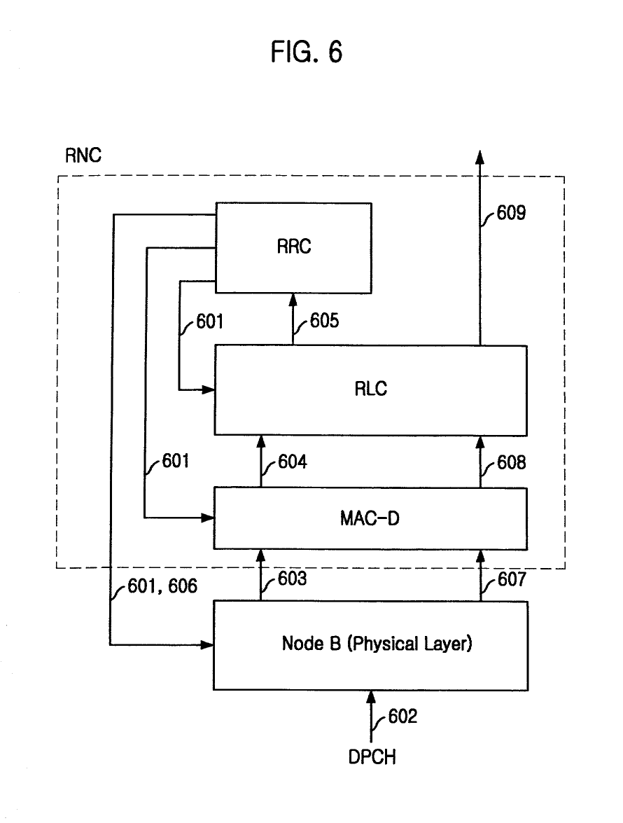

FIG. 6 is a diagram showing a data processing method of a receiver in accordance with the present invention.

As illustrated in FIG. 6, the RLC protocol entity, the MAC-D protocol entity, the MAC-C/SH protocol entity and the physical layer are initialized by the RRC protocol entity to perform normal operation in each of the protocol entity at step 601.

Then, the physical layer of the receiver node B receives a radio frame having the RLC-PDU and the HARQ-RLC-Control-PDU transmitted from the transmission part through the physical channel, such as the DPCH at step 602.

After that, the physical layer of the receiver node B carries out the demodulating, the deinterleaving and the decoding processes to the HARQ-RLC-ControlPDU that is received through the physical channel, such as the DPCH, then transmits the HARQ-RLC-Control-PDU to the MAC-D protocol entity through the transport channel, such as the DCH. At this time, the radio frame that has the received RLC-PDU is stored in the buffer. A data identifier is generated to identify the RLC-PDU stored in the buffer and is transmitted to the MAC-D protocol entity with HARQ-RLC-Control-PDU at step 603. At this time, lub interface is used between the node B and MAC-D.

Subsequently, the MAC-D protocol entity receives the HARQ-MACControl-PDU having the HARQ-RLC-Control-PDU, and the data identifier from the physical layer, and transforms the HARQ-MAC-Control-PDU to the HARQ-RLCNY02 Control-PDU, then transmits the HARQ-RLC-Control-PDU and the data identifier to the RLC protocol entity through the logical channel, such as the DTCH at step 604.

In case of using the same type of the logical channel, the MAC-D protocol entity receives the HARQ-MAC-Control-PDU having the HARQ-RLC-Control-PDU, and the data identifier from the physical layer, and transforms the HARQ-MAC-Control-PDU to the HARQ-RLC-Control-PDU, then transmits the HARQ-RLC-Control-PDU and the data identifier to the RLC protocol entity through the logical channel, such as the DTCH.

The RLC protocol entity interprets the received HARQ-RLC-Control-PDU to extracts the sequence number and the version number, then transmits CRLC-HARQINC primitive having the sequence number, the version number and the data identifier as parameters, to the RRC protocol entity through a control SAP at step 605.

Next, the RRC protocol entity transmits a CPHY-HARQ-REQ primitive that has the sequence number, the version number and the data identifier, which are parameters of the CRLC-HARQ-IND primitive as parameters, to the physical layer through a control SAP between the RRC and the physical layer L1 at step 606.

Then the physical layer of the receiver extracts the radio frame, which has the RLC-PDU stored in the buffer, by using the received data identifier, and carries out the demodulating, the deinterleaving and the decoding processes to the radio frame by using the sequence number and the version number, then transmits the radio frame to the MAC-D protocol entity by using the transport channel, such as the DCH at step 607. That is, node B-L1 determines whether directly decoding the RLC-PDU stored in the buffer by using the sequence number, the version number and the data identifier or to decode after combining with the RLC-PDU of previous version number, then performs decoding and transmits the decoded RLC-PDU to the MAC-D protocol entity through a transport channel, such as the DCH.

After that, the MAC-D protocol entity transmits the received RLC-PDU to the RLC protocol entity through a logical channel, such as the DTCH at step 608.

The RLC protocol entity interprets the received RLC-PDU and transmits it to the upper layer at step 609.

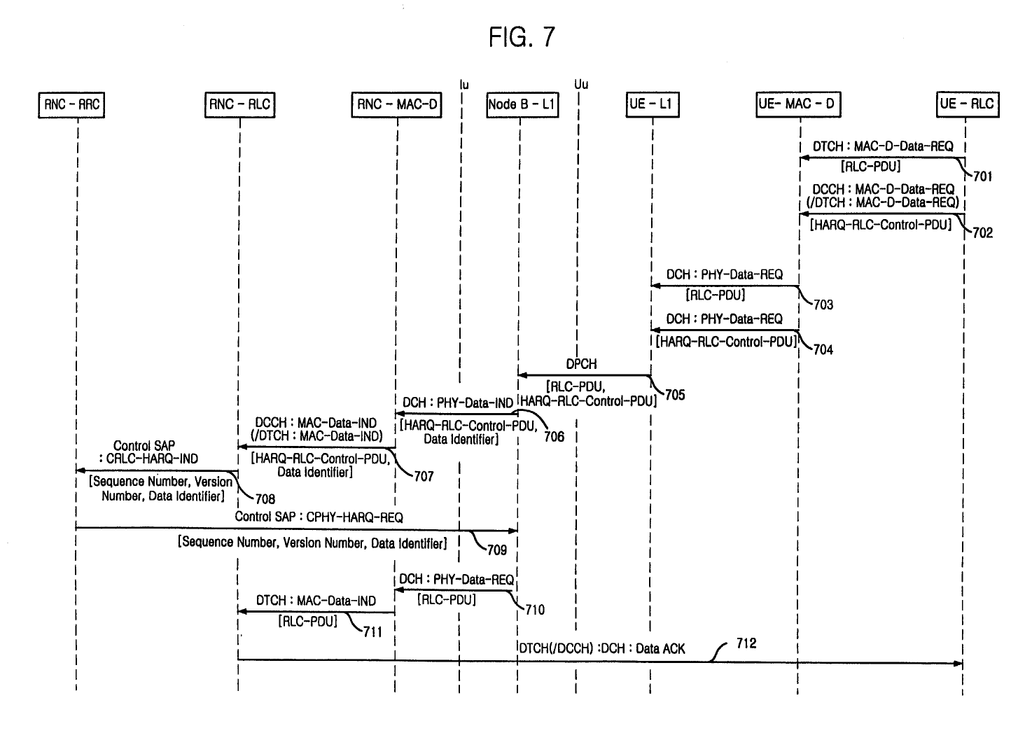

FIG. 7 is a flow chart showing a data processing method in accordance with the present invention.

First, a UE-RLC protocol entity generates RLC-PDU and transmits the generated RLC-PDU to a UE-MAC-D protocol entity through a logical channel (MAC-DData-REQ primitive), such as DTCH at step 701.

The UE-RLC protocol entity generates the HARQ-RLC-Control-PDU by using header information of the RLC-PDU and transmits the generated HARQ-RLCControl-PDU to the UE-MAC-D protocol entity by using a logical channel (MAC-DData-REQ primitive), such as the DCCH at step 702. At this time, the generated HARQRLC-Control-PDU includes information like the sequence number and the version number.

In case of using the same type of the logical channel, the UE-RLC protocol entity generates the HARQ-RLC-Control-PDU (of course, it includes the sequence number and the version number information) by using header information of the RLCPDU and transmits the generated HARQ-RLC-Control-PDU to the UE-MAC-D protocol entity by using the logical channel (MAC-D-Data-REQ primitive), such as the DTCH.

After that, the UE-MAC-D protocol entity transforms the RLC-PDU to the MAC-PDU to use the transport channel, such as the DCH, and transmits the MAC-PDU to the physical layer through the transport channel (PHY-Data-REQ primitive), such as the DCH at step 703.

The UE-MAC-D protocol entity transforms the HARQ-RLC-Control-PDU to the HARQ-MAC-Control-PDU to use the transport channel, such as the DCH, and transmits the HARQ-MAC-Control-PDU to the physical layer through a transport channel (PHY-Data-REQ primitive), such as the DCH at step 704.

The physical layer transmits the received MAC-PDU and the HARQ-MAC-Control-PDU to a radio network through the physical channel, such as the DPCH, after passing the coding, the interleaving and the modulating processes at step 705.

Node B-Li of the radio network receives the radio frame that has the RLC-PDU and the HARQ-RLC-Control-PDU from the UE-L1 through the physical channel, such as the DPCH and carries out the demodulating, the deinterleaving and the decoding processes. Then the radio frame, which has RLC-PDU, is stored in the buffer and the data identifier is generated to identify the radio frame stored in the buffer. After that, the node B-L1 transmits the HARQ-MAC-Control-PDU and the data identifier to a RNC-MAC-D protocol entity through the transport channel (PHY-Data-IND primitive), such as the DCH at step 706.

The RNC-MAC-D protocol entity transmits the HARQ-RLC-Control-PDU and the data identifier to a RNC-RLC protocol entity through the logical channel (MACD-Data-IND primitive), such as the DCCH at step 707. In case of using the RNC-MAC-D protocol entity, the HARQ-RLC-Control-PDU and the data identifier are transmitted to the RNC-RLC protocol entity through the logical channel (MAC-D-Data-IND primitive), such as the DTCH.

Subsequently, the RNC-RLC protocol entity interprets the received HARQ-RLC-Control-PDU and extracts the sequence number and the version number. The data identifier, the sequence number and the version number are transmitted to the RNC-RRC protocol entity as a CRLC-HARQ-IND primitive by using a control SAP defined between the current RLC-PDU and the RNC-RRC protocol entity at step 708.

Then, the RNC-RRC protocol entity transmits the CPHY-HARQ-REQ primitive having the data identifier, the sequence number and the version number as parameters, to the node B-L1 by using a control SAP defined between the current node B-Li and the RNC-RRC at step 709. The node B-L1 carries out the demodulating, the deinterleaving and the decoding processes to the radio frame having the RLC-PDU stored in the buffer by using the received data identifier, and to the radio frame, which is stored by using the sequence number and the version number, then, transmits them to the RNCMAC-D protocol entity through the transport channel (PHY-Data-IND primitive), such as the DCH at step 710.

The RNC-MAC-D protocol entity transmits the received RLC-PDU to the RNC-RLC protocol entity through the logical channel (MAC-D-Data-IND primitive), such as DTCH at step 711.

Finally, the RNC-RLC protocol entity interprets the received RLC-PDU to transform it to an original data form and transmits the RLC-PDU to the upper layer then, transmits a response to the UE-RLC protocol entity at step 712.

As described above, the present invention assumes an asynchronous radio communication system as a preferred embodiment, however, a synchronous radio communication system using the hybrid ARQ type II/III also has a changeable coding rate and information of currently received RLC-PDU to carry out combining a pre-transmitted data and a re-transmitted data to increase system efficiency, and can stably transmit the RLC-PDU information holding data with the data to be transmitted. Therefore, the synchronous radio communication system is the same as the preferred embodiment of the present invention.

In the present invention, in case of an radio communication system uses the hybrid ARQ type II/III, there no changes are required to the pre-defined kinds and format of the RLC data PDU and control PDU. The invention adds a HARQ-RLC-Control-PDU of a new RLC-PDU type so that the hybrid ARQ type II/III is easily used without changing of the conventional RLC protocol entity operation.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. A data processing method for the hybrid ARQ type II/III on a uplink of a wide-band radio communication system, comprising the steps of:
a) generating a radio link control-protocol data unit (hereinafter, referred to as a RCL-PDU) used for combining pre-transmitted data and a re-transmitted data with a changeable coding rate in a radio link control (hereinafter, referred to as a RLC) layer, and a protocol data unit which includes information from the RLC-PDU (hereinafter, referred to as a HARQ-RLC-Control-PDU);
b) transmitting the RLC-PDU and the HARQ-RLC-Control-PDU to a medium access control dedicated (hereinafter, referred to as a MAC-D) treating a general user part in a medium access control (hereinafter, referred to as a MAC) layer through a logical channel;
c) transforming the RLC-PDU and the HARQ-RLC-Control-PDU received from the receiver RLC layer to MAC-PDU and HARQ-MAC-Control-PDU and transmitting the transformed MAC-PDU and the HARQ-MAC-Control-PDU to a physical layer through a transport channel; and
d) transforming the MAC-PDU and the HARQ-MAC-Control-PDU received from the MAC-D to a radio transmission form and then transmitting them to a receiver through the physical layer.

2. The data processing as recited in the claim 1, wherein the HARQ-RLCControl-PDU includes a sequence number and a version number of the RLC-PDU and data identifying information to identify the RLC-PDU.

3. The data processing method as recited in the claim 2, further includes the steps of:
e) storing a received RLC-PDU to a buffer and generating a data identifier to identify the RLC-PDU, then transmitting the RLC-PDU and the HARQ-RLC-Control-PDU to the MAC-D of the receiving MAC layer through a transport channel;
f) transmitting the HARQ-RLC-Control-PDU and the data identifier to the receiving RLC layer through a logical channel;
g) transmitting a sequence number and a version number acquired by analyzing the HARQ-RLC-Control-PDU to a radio resource control (hereinafter, referred to as a RRC) layer with the data identifier;
h) transmitting the sequence number, the version number and the data identifier to the physical layer;
i) determining whether to decode the RLC-PDU stored in the buffer directly by using the sequence number, the version number and the data identifier or to decode after combining with the RLC-PDU of a previous version, then transmitting the decoded RLC-PDU to a receiver physical layer;
j) transmitting the decoded RLC-PDU to the MAC-D through the transport channel;
k) transmitting the RLC-PDU received from the receiving physical layer to the receiving RLC layer through the logical channel; and
l) transmitting the RLC-PDU after analyzing it in the RLC layer to an upper layer and transmitting a response to the receiver RLC layer.

4. The data processing method as recited in the claim 3, wherein in the step g), transmitting the sequence number and the version number acquired by analyzing the HARQ-RLC-Control-PDU in the receiving RLC layer to the receiving RRC layer through a CRLC-HARQ-IND primitive with the data identifier.

5. A data processing method for the hybrid ARQ type II/III on an uplink of a wide-band radio communication system, comprising the steps of:
a) storing a radio link control-protocol data unit (hereinafter, referred to as a RLC-PDU) to a buffer and generating a data identifier to identify the RLC-PDU then, transmitting the RLC-PDU with a protocol data unit which includes information from the RLC-PDU (hereinafter, referred to as a HARQ-RLC-Control-PDU) to a medium access control dedicated (hereinafter, referred to as a MAC-D), which treats a general user equipment of a MAC layer, through a transport channel;
b) transmitting the HARQ-RLC-Control-PDU and the data identifier to the RLC layer through a logical channel;
c) transmitting a sequence number and a version number acquired by analyzing the HARQ-RLC-Control-PDU to a radio resource control (hereinafter, referred to as a RRC) with the data identifier;
d) transmitting the sequence number, the version number and the data identifier to the physical layer;
e) determining whether to decode the RLC-PDU stored in the buffer directly by using the sequence number, the version number and the data identifier, or to decode the RLC-PDU after combining it with an RLC-PDU of a previous version, then transmitting the decoded RLC-PDU to a physical layer;
f) transmitting the decoded RLC-PDU to the MAC-D through the transport channel;
g) transmitting the RLC-PDU received from the physical layer to the RLC layer through the logical channel; and
h) transmitting the RLC-PDU after analyzing it in the RLC layer to an upper layer and transmitting a response to the RLC layer of the user equipment.

6. The data processing method as recited in claim 5, wherein in the step c) comprises transmitting the sequence number and the version number acquired by analyzing the HARQ-RLC-Control-PDU in the RLC layer to the RRC layer through a CRLC-HARQ-IND primitive with the data identifier.

7. The data processing method as recited in claim 5, wherein in the step d) comprises transmitting the sequence number, the version number and the data identifier to a physical layer through a CPHY-HARQ-REQ primitive.

8. The data processing method as recited in claim 5, wherein the radio network is an asynchronous radio network.

9. The data processing method as recited in claim 1, wherein the logical channel is a dedicated traffic channel (DTCH) for transmitting the RLC-PDU and the HARQ-RLC-Control-PDU.

10. The data processing method as recited in claim 1, wherein the logical channel includes the DTCH and a dedicated control channel (DCCH) for transmitting the RLC-PDU and the HARQ-RLC-Control-PDU, respectively.

11. The data processing method as recited in claim 1, wherein the transport channel is a dedicated channel (DCH) for transmitting the RLC-PDU and the HARQRLC-Control-PDU.

12. The data processing method as recited in claim 1, wherein the physical channel is a dedicated physical channel (DPCH) for transmitting the RLC-PDU and the HARQ-RLC-Control-PDU.

13. The data processing method as recited in claim 1, wherein the transmitter is a user equipment (UE).

14. The data processing method as recited in claim 13, wherein the receiver is part of an asynchronous radio network.

15. A computer readable data recording media having instructions for implementing a data processing method for a hybrid ARQ type II/III on a uplink of a wide-band radio communication system having a processor, comprising the functions of:
a) generating a radio link control-protocol data unit (hereinafter, referred to as a RCL-PDU) used for combining pre-transmitted data and a re-transmitted data with a changeable coding rate in a radio link control (hereinafter, referred to as a RLC) layer and, and a protocol data unit which includes information of the RLC-PDU (hereinafter, referred to as a HARQ-RLC-Control-PDU);
b) transmitting the RLC-PDU and the HARQ-RLC-Control-PDU to a medium access control dedicated (hereinafter, referred to as a MAC-D) treating a general user part in a medium access control (hereinafter, referred to as a MAC) layer through a logical channel;
c) transforming the RLC-PDU and the HARQ-RLC-Control-PDU received from the RLC layer to MAC-PDU and HARQ-MAC-Control-PDU and transmitting the transformed MAC-PDU and the HARQ-MAC-Control-PDU to a physical layer through a transport channel; and
d) transforming the MAC-PDU and the HARQ-MAC-Control-PDU received from the MAC-D to a radio transmission form and then transmitting them to a receiver through the physical layer.

16. The computer readable data recording media as recited in claim 15, further includes the functions of:
e) storing a received RLC-PDU to a buffer and generating a data identifier to identify the RLC-PDU, then transmitting the RLC-PDU and the HARQ-RLCControl-PDU to the MAC-D of the receiving MAC layer through the transport channel;
f) transmitting the HARQ-RLC-Control-PDU and the data identifier to the receiving RLC layer through a logical channel,
g) transmitting a sequence number and a version number acquired by analyzing the HARQ-RLC-Control-PDU to a radio resource control (hereinafter, referred to as a RRC) layer with the data identifier;
h) transmitting the sequence number, the version number and the data identifier to the physical layer;
i) determining whether to decode the RLC-PDU stored in the buffer directly by using the sequence number, the version number and the data identifier or to decode the RLC-PDU after combining it with the RLC-PDU of a previous version, then, transmitting the decoded RLC-PDU to a receiver physical layer;
j) transmitting the decoded RLC-PDU to the MAC-D through the transport channel;
k) transmitting the RLC-PDU received from the receiving physical layer to the receiving RLC layer through the logical channel; and
l) transmitting the RLC-PDU after analyzing it in the RLC layer to an upper layer and transmitting a response to the receiver RLC layer.

17. A computer readable data recording media having instructions for implementing a data processing method for a hybrid ARQ type II/III on a uplink of a wide-band radio communication system having a processor, comprising the functions of:
a) storing a radio link control-protocol data unit (hereinafter, referred to as a RLC-PDU) to a buffer and generating a data identifier to identify the RLC-PDU, then, transmitting the RLC-PDU with a protocol data unit which includes information from the RLC-PDU (hereinafter, referred to as a HARQ-RLC-Control-PDU) to a medium access control dedicated (hereinafter, referred to as a MAC-D), treating a general user equipment of a MAC layer, through a transport channel;
b) transmitting the HARQ-RLC-Control-PDU and the data identifier to the RLC layer through a logical channel;
c) transmitting a sequence number and a version number acquired by analyzing the HARQ-RLC-Control-PDU to a radio resource control (hereinafter, referred to as a RRC) with the data identifier;
d) transmitting the sequence number, the version number and the data identifier to the physical layer;
e) determining whether to decode the RLC-PDU stored in the buffer directly by using the sequence number, the version number and the data identifier, or to decode the RLC-PDU after combining it with an RLC-PDU of a previous version, then transmitting the decoded RLC-PDU to the physical layer;
f) transmitting the decoded RLC-PDU to the MAC-D through the transport channel;
g) transmitting the RLC-PDU received from the physical layer to the RLC layer through the logical channel; and
h) transmitting the RLC-PDU after analyzing it in the RLC layer to an upper layer and transmitting a response to the RLC layer of the user equipment.
